(19) United States
(12) Patent Application Publication
(10) Pub. No.: US 2008/0118104 A1
(43) Pub. Date: May 22, 2008

(54) HIGH FIDELITY TARGET IDENTIFICATION AND ACQUISITION THROUGH IMAGE STABILIZATION AND IMAGE SIZE REGULATION

(75) Inventors: Kartik B. Ariyur, Minneapolis, MN (US); Vassilios Morellas, Plymouth, MN (US); Saad J. Bedros, West St. Paul, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/562,563

(22) Filed: Nov. 22, 2006

(51) Int. Cl. G06K 9/00

(52) U.S. Cl. 382/103

(57) ABSTRACT

A system to identify targets comprising a camera module to track a target and to generate a relatively stable image of the target while the target moves with respect to the camera module, sensors to sense a movement of the camera module and to generate sensor data, a memory storing a database of possible targets and a programmable processor communicatively coupled to each of the memory, the camera module and the sensors. The programmable processor receives signals comprising information indicative of the image from the camera module and executes instructions in an instruction module. The instructions comprise exponentially stabilizing control laws based at least in part on the sensor data. The programmable processor executes instructions in the instruction module to determine a pattern match between the stable image of the target and one of the possible targets in the database.

This application is related to U.S. patent application Ser. No. ______ (Attorney Docket No. H0012162-5607) having a title of “A STATIC CAMERA TRACKING SYSTEM” (also referred to here as the “H0012162-5607 Application”) filed on Jun. 12, 2006. The H0012162-5607 Application is hereby incorporated herein by reference.

U.S. patent application Ser. No. 11/470,048 (Attorney Docket No. H0012164.73239 (5607)) having a title of “TRACKING A MOVING OBJECT FROM A CAMERA ON A MOVING PLATFORM” (also referred to here as the “11/470,048 Application”), filed on Sep. 9, 2006. The Ser. No. 11/470,048 Application is hereby incorporated herein by reference.

### BACKGROUND

Identification of objects (e.g., faces or tanks) by pattern recognition is easier when the object is static. In general, it is difficult to identify objects that are executing general motion. Although pattern recognition works much better for stationary objects, many objects to be identified are moving. For example, a pilot in an aircraft, which is tracking another aircraft as a potential enemy, needs to identify the tracked aircraft as an enemy target prior to taking hostile action. Likewise, cameras positioned to image pedestrians and motorists on city streets can be used to identify potential terrorists, if the tracked person stands still for the duration of time required for a pattern recognition to be executed on the image generated at the camera.

There are many applications in which it is desirable to identify objects in motion including manufacturing, security, and military applications.

### SUMMARY

A system to identify targets comprising a camera module to track a target and to generate a relatively stable image of the target while the target moves with respect to the camera module, sensors to sense a movement of the camera module and to generate sensor data, a memory storing a database of possible targets and a programmable processor communicatively coupled to each of the memory, the camera module and the sensors. The programmable processor receives signals comprising information indicative of the image from the camera module and executes instructions in an instruction module. The instructions comprise exponentially stabilizing control laws based at least in part on the sensor data. The programmable processor executes instructions in the instruction module to determine a pattern match between the stable image of the target and one of the possible targets in the database.

### DRAWINGS

FIG. 1 is a block diagram of one embodiment of a system to identify targets in accordance with one embodiment of the present invention.

FIGS. 2 and 3 are diagrams representative of a system and a target as seen from a top view and a side view, respectively, in accordance with one embodiment of the present invention.

FIGS. 4A-4B are diagrams representative of the imaging elements in the imaging device on which target-images are focused from different vantage points.

FIG. 5 illustrates two system carriers communicatively coupled to transmit instructions to track a target in accordance with one embodiment of the present invention.

FIG. 6 illustrates a block diagram of the two system carriers of FIG. 5 that are communicatively coupled to transmit instructions to track a target in accordance with one embodiment of the present invention.

FIG. 7 is a flow diagram of one embodiment of a method to identify targets in accordance with one embodiment of the present invention.

FIG. 8 is a flow diagram of one embodiment of a method to dynamically stabilize a target image formed on an image plane of an imaging device located in a moving vehicle in accordance with one embodiment of the present invention.

FIG. 9 is a flow diagram of one embodiment of a method to dynamically stabilize a target image formed on an image plane of an imaging device located in a moving vehicle in accordance with one embodiment of the present invention.

FIG. 10 is a block diagram of one embodiment of a system to identify targets in accordance with one embodiment of the present invention.

FIG. 11 is a block diagram of one embodiment of a system to identify targets in accordance with one embodiment of the present invention.

FIG. 12 is a block diagram of one embodiment of a system to identify targets in accordance with one embodiment of the present invention.

FIG. 13 is a block diagram of one embodiment of a system to identify targets in accordance with one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

In order to use pattern recognition algorithms to identify objects that are moving in with respect to an imaging system, the position and size of the image of the object that is formed at the image plane of the imaging device must be regulated for a sufficient period of time (a few seconds). For higher reliability of pattern recognition to be obtained, higher fidelity algorithms for pattern recognition, which take longer than a few seconds to implement, can be employed. In this latter case, the position and size of the image of the tracked object that is formed at the image plane of the imaging device must be regulated for an even longer time (greater than a few seconds).

The system described herein combines image position and size stabilization with higher fidelity pattern recognition to achieve high reliability pattern recognition. The system described herein permits the fidelity of pattern recognition available for recognition of static objects to be used to determine a pattern match between the stable image of the object and a possible target in a database. In this case, the system can be used if the imaging device is moving with respect to the object, if the object is moving with respect to the imaging device and also if the object and the imaging device are both simultaneously moving with respect to a global coordinate system. Thus, the system described herein increases the reliability of pattern recognition when used to track and identify targets.

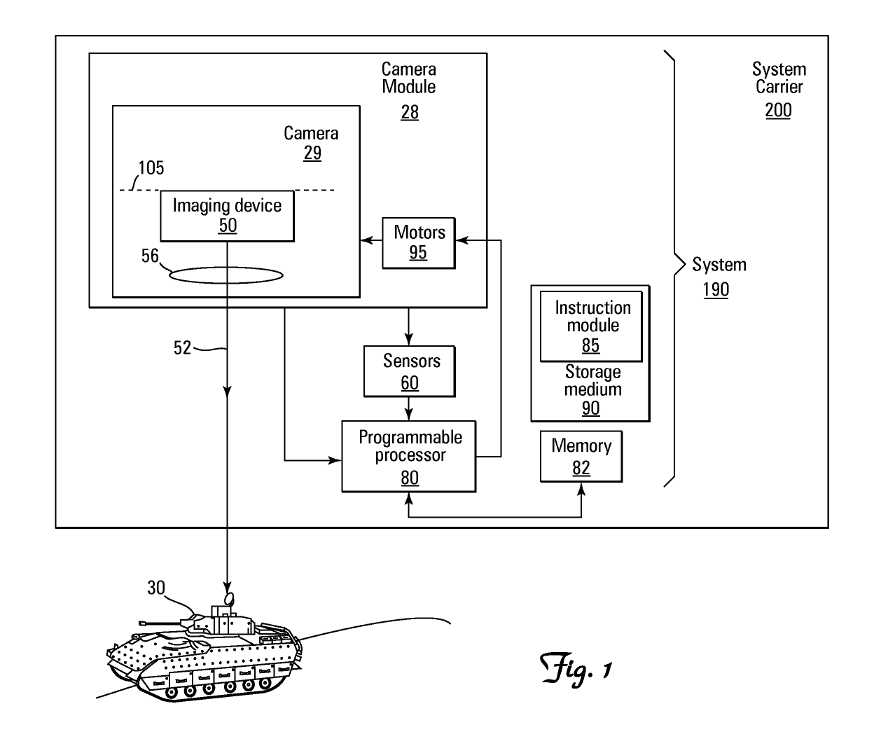

FIG. 1 is a block diagram of one embodiment of a system 190 to identify targets 30 in accordance with one embodiment of the present invention. The terms “targets,” “tracked targets,” and “objects” are used interchangeably throughout this document. The system 190 includes a camera module 28, sensors 60, a programmable processor 80, a memory 82, and instructions in an instruction module 85 stored in a storage medium 90. The system 190 is enclosed in a system carrier 200, which may be a mobile vehicle, such as an aircraft. The terms “vehicle,” and “system carrier” are used interchangeably throughout this document. The camera module 28 of the system 190 shown in FIG. 1 is focused on a target 30, such as a military tank. The instructions in the instruction module 85 include pattern recognition algorithms.

The camera module 28 includes a camera 29 and motors 95. The motors 95 position the camera 29 responsive to instructions received from the programmable processor 80. The camera 29 includes an imaging device 50 having an image plane shown in cross section in FIG. 1 as dashed line 105 and a lens system generally represented by a single lens 56. The lens system 56 has an optical axis 52. The lens system 56 focuses images on the image plane 105. In one implementation of this embodiment, the imaging device 50 includes imaging elements such as pixels to generate a digital image of the target 30 when the camera 29 is focused on the target 30 as is known in the art. Examples of commercially available electronic imaging devices include the Sony ICX428AKL CCD Image Sensor, the MT9D112 SOC COMS Image Sensor, and the CIDTEC Spectra CAM. In another implementation of this embodiment, the lens system 56 includes a negative refractive index lens to provide high resolution with low weight. In yet another implementation of this embodiment, the lens system 56 includes any suitable lens system now known or later developed.

The camera module 28 tracks the target. The sensors 60 sense a movement of the camera module 28 and generate sensor data. The programmable processor 80 is communicatively coupled to receive the sensor data from the sensors 60. The programmable processor 80 executes instructions comprising exponentially stabilizing control laws based, at least in part, on the received sensor data, so that the image of the target 30 formed on the image plane 105 is stationary even if the target 30 and camera module 28 are in motion with respect to each other. In this manner, the camera module 28 generates a relatively stable image of the target 30 that moves with respect to the camera 29 and the programmable processor 80 is communicatively coupled to receive signals having information indicative of the relatively stable image from the camera module 28 from the camera module 28. As defined herein, a relatively stable image is an image that can be identified during a pattern matching process by using a higher fidelity algorithm that takes longer to execute (and typically requires a stationary target for a reliable identification) as is known in the art.

The memory 82 stores a database of possible targets and is communicatively coupled to the programmable processor 80. The database of possible targets includes images of a plurality of targets to be tracked or potentially to be tracked. While the programmable processor 80 executes instructions to generate a stable image of the target 30, the programmable processor 80 simultaneously executes the instructions to determine a pattern match between the stable image of the target 30 and a possible target, the image of which is in the database. In one implementation of this embodiment, while the programmable processor 80 executes instructions to generate a stable image of the target 30, the programmable processor 80 retrieves at least a portion of the possible targets from the memory 82 and executes the instructions to determine a pattern match between the stable image of the target 30 and the retrieved portion of possible target. In one implementation of this embodiment, the programmable processor 80 temporarily stores the stable image of the target 30 in the memory 82, while executing the instructions to determine a pattern match between the stable image of the target 30 and a possible target.

In one implementation of this embodiment, the database of possible targets includes images of a plurality of targets from various angles. In another implementation of this embodiment, a database of possible targets (e.g., terrorists) comprising images of people's faces includes images of the same person with different facial expressions. In yet another implementation of this embodiment, the database of possible targets includes images of all the military tanks, military aircraft, and commercial aircrafts known to be in current use by several countries.

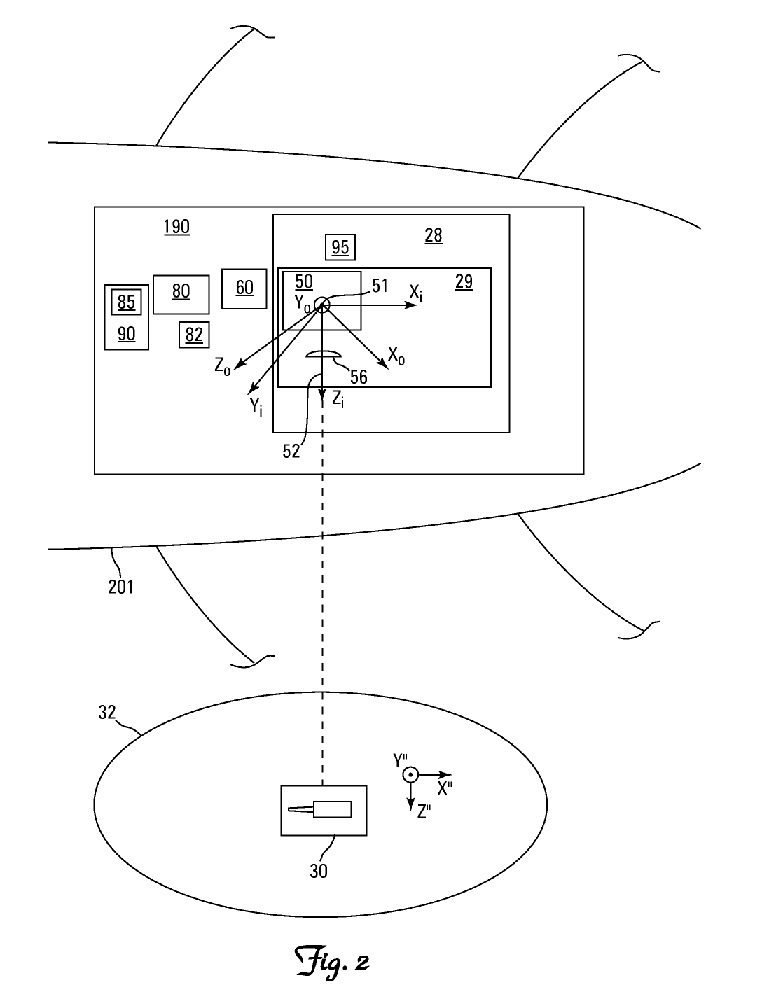

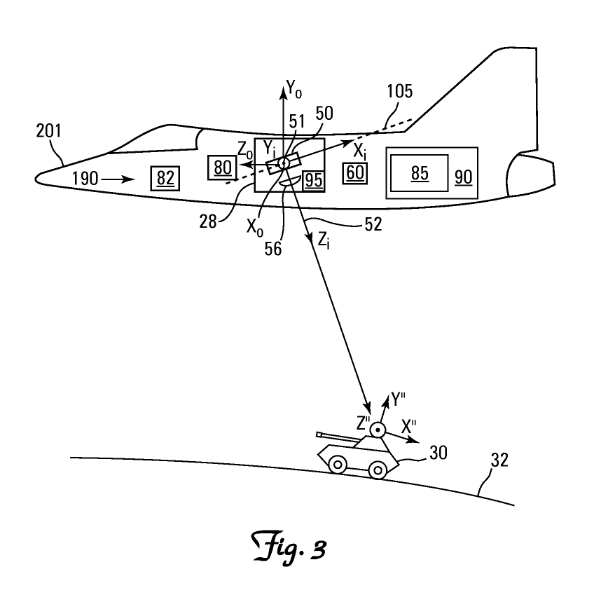

In one implementation of this embodiment, the system carrier 200 is a moving vehicle, such as an airborne vehicle, and the camera 29 has pan, tilt and zoom capability. The terms “aircraft” and “airborne vehicle” are used interchangeably throughout this document. This embodiment is shown in FIGS. 2 and 3. FIGS. 2 and 3 are diagrams representative of a system 190 and a target 30 as seen from a top view and a side view, respectively. As shown in FIGS. 2 and 3, a vehicle 201 (of which only a portion is shown in FIG. 2) is moving with respect to target 30 located on the surface of the earth represented generally by numeral 32. In this exemplary implementation, the vehicle 201 is an aircraft 201, which is the system carrier 201, so the terms “vehicle 201,” “aircraft 201 ” and “system carrier 201” are used interchangeably. As shown in FIG. 2, the target 30 is a tank. Other types of vehicles and targets are possible. For example, the vehicle can be a water vehicle, a land vehicle, a satellite, or movable platform to which the camera 29 is attached. The target 30 is any object, either stationary or moving. The target 30 is located at a position having global coordinates X″, Y″, and Z″. In one implementation of this embodiment, the target is moving and the global coordinates X″, Y″, and Z″ are changing in time in a manner correlated to the movement of the target 30.

In this implementation, the imaging device 50 is rotatably positioned within the camera module 28 that is fixedly attached to the system carrier 200. For example, the camera module 28 can be attached to the ceiling or underside of the aircraft 201. The system 190, as described above with reference to FIG. 1, also includes sensors 60, a programmable processor 80, memory 82, instructions in the instruction module 85 stored in a storage medium 90 and at least one motor 95.

The imaging device 50 is also referred to herein as pan-tilt-zoom (PTZZ) camera 50. The lens system 56 focuses images on an image plane shown in cross section in FIG. 3 as dashed line 105. The image plane 105 is in the plane containing a first axis Xᵢ and a second axis Yᵢ, which orthogonally intersect with each other at the origin represented generally by the numeral 51. The optical axis 52 orthogonally intersects the image plane 105 at the origin 51. The optical axis 52 is identical to a third axis Zᵢ, thus the origin 51 is at the intersection of the image coordinate axes referred to herein as the imaging device axes Xᵢ, Yᵢ and Zᵢ. When the target image is focused on the image plane 105, the optical axis 52 is along a line from the imaging device 50 to the target 30 so that an extension of the optical axis 52 intersects the target 30.

The imaging device 50 is capable of two rotations: pan and tilt. The imaging device 50 pans when it rotates about the second axis Yᵢ. The imaging device 50 tilts when it rotates about the first axis Xᵢ. The imaging device 50 is fixed so that it cannot rotate about the third axis Zᵢ.

A fourth axis represented generally as Xₒ, a fifth axis represented generally as Yₒ, and a sixth axis represented generally as Zₒ are referred to herein as the inertial axes which define an inertial coordinate system about which the rotations and translations of the system carrier 200 are sensed by sensors 60. In one implementation of this embodiment, the origin 51 is also at the origin of the inertial coordinate system (at the intersection of the Xₒ, Yₒ and Zₒ axes).

In another implementation of this embodiment, the origin of the inertial coordinate system (at the intersection of the Xₒ, Yₒ and Zₒ axes) and the origin 51 of the imaging device 50 are co-located at the center of gravity of the system carrier 201. In another implementation of this embodiment, the origin of the inertial coordinate system is located at the center of gravity of the system carrier 201 while the origin 51 of the imaging device 50 (at the intersection of the Xᵢ, Yᵢ and Zᵢ axes) is offset from the center of gravity of the system carrier 201. In this case, translation and rotation algorithms are implemented by the programmable processor 80 when stabilizing the target image formed on the image plane 105 in order to adjust for this offset of the origin 51 from the center of gravity. Such translation and rotation algorithms are known in the art.

In an exemplary case, the imaging device 50 is mounted on the ceiling of the system carrier 201 (e.g., aircraft 201) and the inertial coordinate system is set as follows: the sixth axis Zₒ lies in a plane parallel to the plane of the ceiling and sixth axis Zₒ is identical to the optical axis 52 of the imaging device 50 when the optical axis 52 is at zero degrees (0°) of pan and zero degrees (0°) of tilt; the fifth axis Yₒ is perpendicular to the ceiling and fifth axis Yₒ is parallel to the second axis Yᵢ when the optical axis 52 is at zero degrees of pan and zero degrees of tilt; the fourth axis Xₒ is orthogonal to the optical axis 52 of the imaging device 50 and is identical to the first axis Xᵢ when the optical axis 52 is at zero degrees of pan and zero degrees of tilt.

The vehicle 201 is capable of three rotations; pitch, yaw, and roll. The vehicle 201 pitches when it rotates about the fourth axis Xₒ. The vehicle 201 yaws when it rotates about the fifth axis Yₒ. The vehicle 201 rolls when rotated about the sixth axis Zₒ.

The system 190 includes at least one motor 95 that mechanically couples the camera module 28 and to the imaging device 50. When the system 190 is tracking a target 30, the motors 95 rotate the imaging device 50 so that the optical axis 52 always points toward the target 30. The motors 95 receive operational instructions that are based on rotation output generated when the programmable processor 80 executes exponentially stabilizing control laws. The rotation output initiates a rotation operation by the motors 95 to rotate the imaging device 50 within the camera module 28. In one implementation of this embodiment, the motors 95 are attached to the vehicle 201 and mechanically couple the camera module 28 and to at least one surface of the vehicle 201. The programmable processor 90 is communicatively coupled (either wired or wirelessly) to the motors 95 and the instructions executing on the programmable processor 80 sends at least a portion of the information indicative of the operation instructions (or information derived therefrom such as a “compressed” version of such operation instructions) to the motors 95.

In one implementation of this embodiment, the motors 95 include one or more processors (not shown) to receive signals on or in which such operation instructions are encoded or otherwise included. Such processors activate the mechanical couplings based on the received operation instructions (or data indicative thereof). The motors 95 can include actuators such as piezo-electric actuators.

The sensors 60 sense translation and rotations of the vehicle 201 about the fourth axis Xₒ, the fifth axis Yₒ and the sixth axis Zₒ. In one implementation of this embodiment, the sensors 60 include a first gyrocompass aligned to the fourth axis Xₒ, a second gyrocompass aligned to the fifth axis Yₒ, a third gyrocompass aligned to the sixth axis Zₒ, a first accelerometer aligned to the fourth axis Xₒ, a second accelerometer aligned to the fifth axis Yₒ, a third accelerometer aligned to the sixth axis Zₒ. In another implementation of this embodiment, the sensors 60 include an inertial measurement unit. In yet another implementation of this embodiment, the sensors 60 include an inertial measurement unit and a global positioning system. In yet another implementation of this embodiment, the sensors 60 include an inertial navigation system. In yet another implementation of this embodiment, the sensors 60 include an inertial navigation system and a global positioning system. In one implementation of this embodiment, the sensors 60 are located in the camera module 28.

An exemplary inertial navigation unit is an inertial measuring unit (IMU) containing inertial sensors which measure components of angular rate and sensed acceleration. The measured angular rates and accelerations are used to compute the equivalent angular rates and sensed accelerations along the set of orthogonal IMU axes, such as Xₒ, Yₒ and Zₒ that constitute the IMU reference frame.

The programmable processor 80 is communicatively coupled to receive sensor data from the sensors 60 and to generate rotation output to stabilize the target image formed on the image plane of the imaging device 50 when the vehicle 201 moves with respect to the target 30. The programmable processor 80 also implements the exponentially stabilizing control laws to maintain a target-image size as the distance between the vehicle 201 and the target 30 changes. The programmable processor 80 generates zoom output to stabilize the target-image size within a selected size range as the distance between the vehicle 201 and the target 30 varies.

The exponentially stabilizing control laws are included in the instructions in the instruction module 85 that is stored or otherwise embodied within the storage medium 90 from which at least a portion of such program instructions are read for execution by the programmable processor 80. As the system carrier 201 tracks the target 30, the exponentially stabilizing control laws generate rotation output and zoom output, which the programmable processor 80 uses to generate the operational instructions for the motor 95. The zoom output stabilizes the target-image size within a selected size range. The rotation output stabilizes the image centroid within a selected distance from the origin 51 or at the origin 51 of the image plane 105.

The Ser. No. 11/470,048 application describes the development of exponentially stabilizing control laws that are used to control the tracking of a target by a static pan-tilt-zoom (PTZ) camera. The exponentially stabilizing control laws that are used to control the tracking of a target by a pan-tilt-zoom (PTZ) camera offset for the roll of the inertial system so that the image size and image location on the imaging plane are stabilized in the pan-tilt-zoom (PTZ) camera, which permits the image stabilization for the duration required to implement higher fidelity algorithms for pattern recognition that are included in the instructions.

The exponentially stabilizing control laws derived in the Ser. No. 11/470,048 application are:

$$\begin{matrix}{u}_{1} ( t - {τ}_{φ} ) = - {δ}_{1} ( t ) - \frac{1}{{z}_{i} - {O}_{c , z}} ( cox φ {\dot{x}}_{o} + sin ω sin φ {\dot{y}}_{o} + cos κ {\dot{O}}_{c , x} + sin κ {\dot{O}}_{c , y} + ( cos ω {y}_{o} - sin ω {z}_{o} ) sin φ \frac{1}{sin ω {y}_{o} + cos ω {z}_{o}} ( cos ω {\dot{y}}_{o} - sin ω {\dot{z}}_{o} - sin κ {\dot{O}}_{c , x} + cos κ {\dot{O}}_{c , y} - {α}_{ω} {\tilde{y}}_{i} ) - {α}_{φ} {\tilde{x}}_{i} ) & ( 1 ) \\ {u}_{2} ( t - {τ}_{ω} ) = - {δ}_{2} ( t ) + \frac{1}{sin ω {y}_{o} + cos ω {z}_{o}} ( cos ω {\dot{y}}_{o} - sin ω {\dot{z}}_{o} - sin κ {\dot{O}}_{c , x} + cox κ {\dot{O}}_{c , y} - {α}_{ω} {\tilde{y}}_{i} ) , & ( 2 ) \\ {u}_{3} ( t - {τ}_{f} ) = f ( \frac{{\dot{z}}_{i}}{{z}_{i}} - {α}_{f} \frac{{w}_{s} - {w}_{ref}}{{w}_{s}} ) & ( 3 )\end{matrix}$$

In the pan, tilt and zoom control laws of equations (1), (2), and (3) respectively, δ₁(t) and δ₂(t) compensate respectively, for the yaw and pitch rates of the moving vehicle 201. The yaw rate, the pitch rate and the roll rates are obtained from the sensors 60 such as an inertial navigation system. The compensation is done in the \tilde{x}ᵢ and \tilde{y}ᵢ coordinates to eliminate the effect of roll since the \tilde{x}ᵢ and \tilde{y}ᵢ coordinates roll with the rolling platform.

The angles used in the control laws must account for vehicle motion in addition to imaging device motion from the previous control input. This is required because the movement of the imaging device 50 is based on the motors 95 which have a latency. The latency for each motor (e.g., pan, tilt and zoom) is known. A feed-forward integration of system dynamics compensates for the known latency. This compensation uses the inertial measurements and control inputs of the present state of the camera. The zoom control law of Equation (3) automatically takes into account the translation of the moving vehicle 201.

Data related to the latency of the system 190 is stored in memory 82 and is retrieved by the programmable processor 80 as needed. Memory 82 comprises any suitable memory now known or later developed such as, for example, random access memory (RAM), read only memory (ROM), and/or registers within the programmable processor 80. In one implementation, the programmable processor 80 comprises a microprocessor or microcontroller. Moreover, although the programmable processor 80 and memory 82 are shown as separate elements in FIGS. 2 and 3 in one implementation, the programmable processor 80 and memory 82 are implemented in a single device (for example, a single integrated-circuit device). In one implementation, the programmable processor 80 comprises processor support chips and/or system support chips such as ASICs. The programmable processor 80 executes instructions in an instruction module 85 to implement software and/or firmware that causes the programmable processor 80 to perform at least some of the processing described here as being performed by the system, such as system 190. At least a portion of such software and/or firmware executed by the programmable processor 80 and any related data structures are stored in storage medium 90 during execution. The software and/or firmware executed by the programmable processor 80 comprises a plurality of program instructions in the instruction module 85 that are stored or otherwise embodied on a storage medium 90 from which at least a portion of such program instructions are read for execution by the programmable processor 80. In one implementation, the programmable processor 80 comprises processor support chips and/or system support chips such as ASICs.

The programmable processor 80 generates rotation output to stabilize the image centroid 53 within a selected distance from the origin 51. The rotation output is based on the output from equations (1), (2), and (3).

The system 190 maintains the image centroid within the selected distance from the origin as the vehicle moves with respect to the target. The system 190 maintains the image centroid within the selected distance from the origin based on the implementation of the exponentially stabilizing control laws (equations (1), (2), and (3)) which are executed by the programmable processor to output rotation output. The programmable processor generates instructions based on the rotation output that cause at least one motor to rotate the imaging device to pan and tilt.

In the exemplary embodiment shown in FIGS. 2 and 3, the programmable processor 80 generates instructions that cause at least one motor 95 to rotate the imaging device 50 about at least one of the first axis Xᵢ and the second axis Yᵢ so that the optical axis 52 of the imaging device 50 is along a line of sight to the target 30.

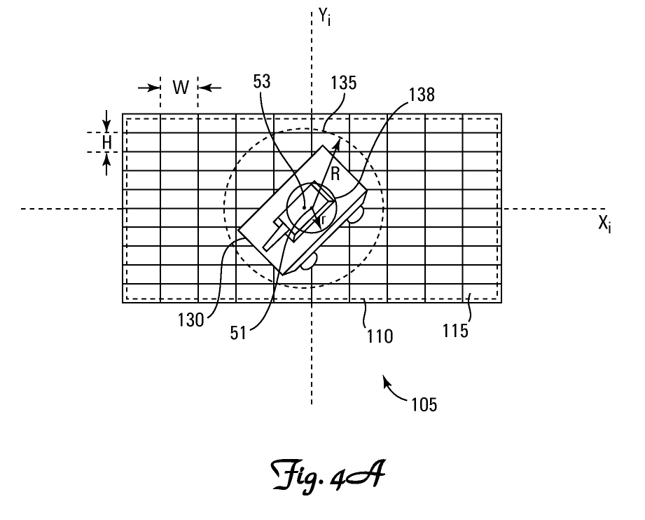

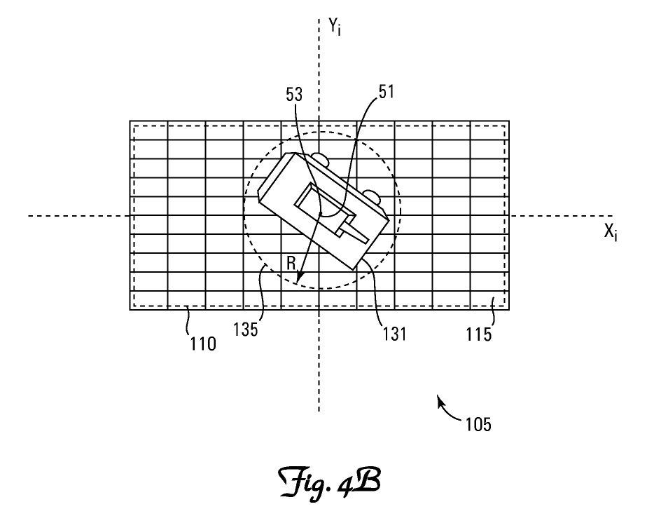

FIGS. 4A-4B are diagrams representative of the imaging elements in the imaging device on which target-images are focused from different vantage points. As shown in FIGS. 4A-4B illustrate two exemplary target-images 130 and 131, respectively, are focused from different vantage points at different times as the vehicle 201 moves with respect to the target 30 and the viewing angle of the target 30 changes.

FIG. 4A is a diagram representative of the imaging elements 115 in the imaging device 50 that are positioned in the image plane 105 that is horizontally bisected by the first axis Xᵢ and vertically bisected by the second axis Yᵢ. An exemplary target image 130 of the exemplary target 30 (FIGS. 1-3) is focused on a portion of the imaging elements 115. The image centroid 53 is an approximate center of the target image 130 and it is at about the intersection of first axis Xᵢ and second axis Yᵢ. The image centroid 53 is slightly offset from the origin 51 but the offset is small with respect to the field of view 110. The field of view 110 of the imaging device 50 overlaps a plurality of the imaging elements 115. The imaging elements each have a width generally represented as W and a height generally represented as H.

As the vehicle 201 moves above the target 30, the target image 130 as seen in FIG. 4A changes to the target image 131 as seen in FIG. 4B. The image centroid 53 of the target image 131 is still within the selected distance from the origin 51.

In the exemplary embodiment shown in FIGS. 4A and 4B, the target images 130 and 131, respectively, fit within the circle 135 of the maximum selected radius R that is centered at the origin 51 in the field of view 110 of the image plane 105. Likewise, the target image 130 extends beyond the circle 138 (FIG. 4A) of the minimum selected radius r centered at the origin 51. As the vehicle 201 moves in closer to the target 30, the zoom output causes the motors 95 to zoom the lens system 56 so the target image size is maintained as shown in FIGS. 4A and 4B. Thus, even if the vehicle 201 is closer to the target when target image 131 is formed, the target image size is maintained due to the zooming of the lens system 56.

In this manner, the programmable processor 80 implements the exponentially stabilizing control laws to maintain a target-image size within a selected size range as the system carrier moves with respect to the target and simultaneously determines a pattern match between the stable image of the target and a possible target in the database.

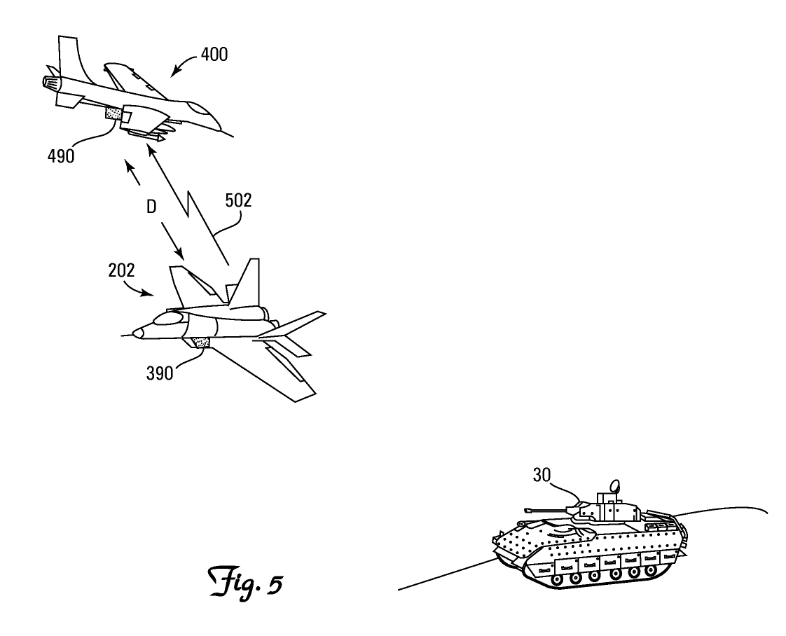

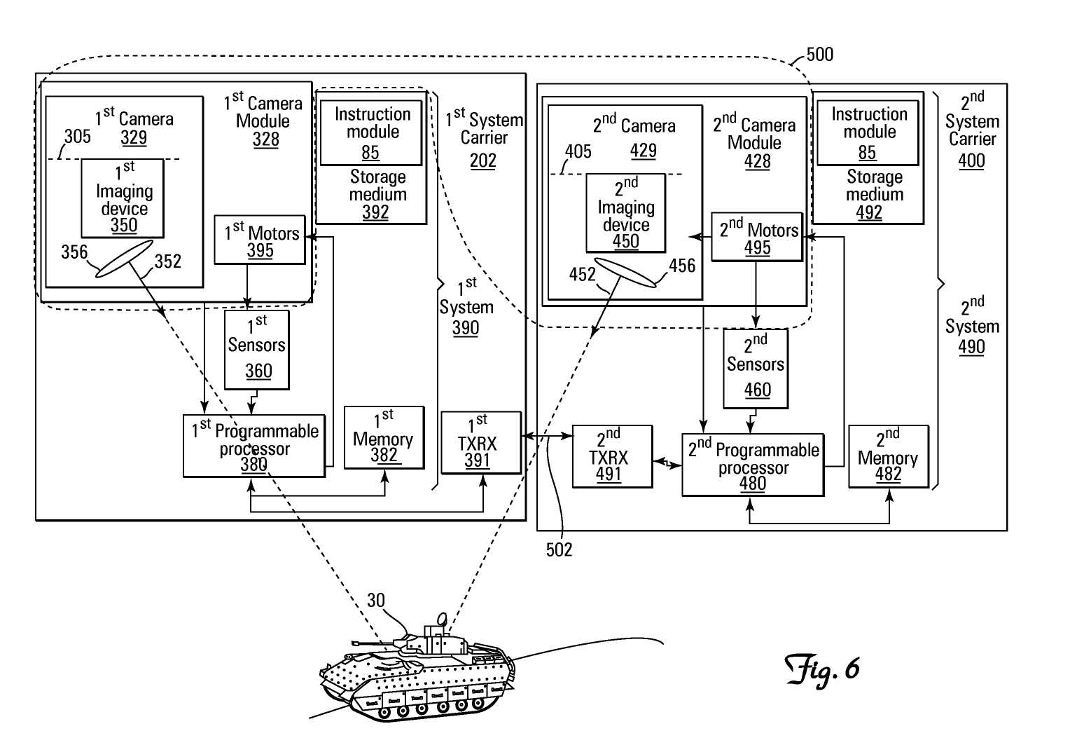

FIG. 5 illustrates two system carriers 202 and 400 communicatively coupled to transmit instructions to track a target 30 in accordance with one embodiment of the present invention. FIG. 6 illustrates a block diagram of the two system carriers 202 and 400 of FIG. 5 that are communicatively coupled to transmit instructions to track a target 30 in accordance with one embodiment of the present invention. In this exemplary implementation of an embodiment, the first carrier system 202 also referred to herein as “first airborne vehicle 202” carries the first system 390 and the second carrier system 400 also referred to herein as “second airborne vehicle 400” carries the second system 490. FIG. 6 illustrates a block diagram of the first airborne vehicle 202 and the second airborne vehicle 400 that are communicatively coupled to each other via the wireless communication link 502. The wireless communication link 502 is established between the first transceiver 391 in the first system carrier 202 and the second transceiver 491 in the second system carrier 400. FIGS. 5 and 6 are illustrative of an embodiment in which the first camera module 329 and 429 form a network 500 of camera module 328 and 428 (FIG. 6) and the signals comprising information indicative of the images from the first camera module 328 (FIG. 6) in the airborne vehicle 202 can be passed to the second camera module 428 (FIG. 6). Each camera module, such as first camera module 328 and second camera module 428, in the network 500 of camera modules is communicatively coupled to a respective programmable processor, such as first programmable processor 380 and second programmable processor 480.

In one implementation of this embodiment, the first airborne vehicle 390 has been tracking the target 30 and, as the first airborne vehicle 202 moves out of visual range of the target 30, the first airborne vehicle 202 passes the tracking instructions to the second airborne vehicle 400 via communication link 502. The second airborne vehicle 400 receives the tracking instructions at the second transceiver 491 and begins to track the target 30, if the second airborne vehicle 400 is in a position to track the target 30. If the second airborne vehicle 400 is not in a position to track the target 30, the second programmable processor 480 sends a signal to indicate that the second airborne vehicle 400 is unable to track the target 30. In another implementation of this embodiment, the first airborne vehicle 202 sends the currently generated stable image of the target 30 to the second airborne vehicle 400 with the tracking instructions.

The first system 390 and the second system 490 have structures and methods of operation similar to the structure and method of operation of system 190, as described above with reference to FIG. 1, in addition to having transceivers 391 and 491, respectively.

Specifically, as shown in FIG. 6, the first system 390 is enclosed with the first transceiver 391 in the first system carrier 202 and includes a first camera module 328, first sensors 360, a first programmable processor 380, a first memory 382, and instructions in the instruction module 85 stored in a storage medium 90. The first camera module 328 of the first system 390 is focused on a target 30. The first camera module 328 includes a first camera 329 and first motors 395. The first camera 329 includes a first imaging device 350 having a first image plane shown in cross section in FIG. 6 as dashed line 305 and a first lens system generally represented by a single lens 356. The first lens system 356 has a first optical axis 352. The first lens system 356 focuses images on the first image plane 305. The first system 390 functions in the same manner as system 190. The first transceiver 391 is communicatively coupled to the first programmable processor 380 and is able to transmit and receive radio frequency signals.

Likewise, the second system 490 is enclosed with the second transceiver 491 in the second system carrier 400 and includes a second camera module 428, second sensors 460, a second programmable processor 480, a second memory 482, and instructions in the instruction module 85 stored in a storage medium 490. The second system 490 is enclosed in the second airborne vehicle 400. The second camera module 428 of the second system 490 shown in FIG. 6 is focused on a target 30. The second camera module 428 includes a second camera 429 and second motors 495. The second camera 429 includes a second imaging device 450 having a second image plane shown in cross section in FIG. 6 as dashed line 405 and a second lens system generally represented by a single lens 456. The second lens system 456 has a second optical axis 452. The second lens system 456 focuses images on a second image plane 405. System 400 functions in the same manner as system 190. The second transceiver 491 is communicatively coupled to the second programmable processor 480 and is able to transmit and receive radio frequency signals.

When the first airborne vehicle 202 is moving out of visual sight of the target 30, the first programmable processor 380 transmits instructions to track the target 30 to the second programmable processor 480. The instructions are sent from the first programmable processor 380 to the first transceiver 391. The first transceiver 391 wirelessly transmits the instructions via the wireless communication link 502 to the second transceiver 491 as is known in the art. The second transceiver 491 receives the instructions and sends the received instructions to the second programmable processor 480. The second programmable processor 491 receives instructions to track the target 30. Responsive to receiving the instructions, the second camera module 248 begins to track the target 30 and to execute instructions comprising exponentially stabilizing control laws based at least in part on the sensor data in order to generate a stable image of the target 30 that moves with respect to the second camera 429.

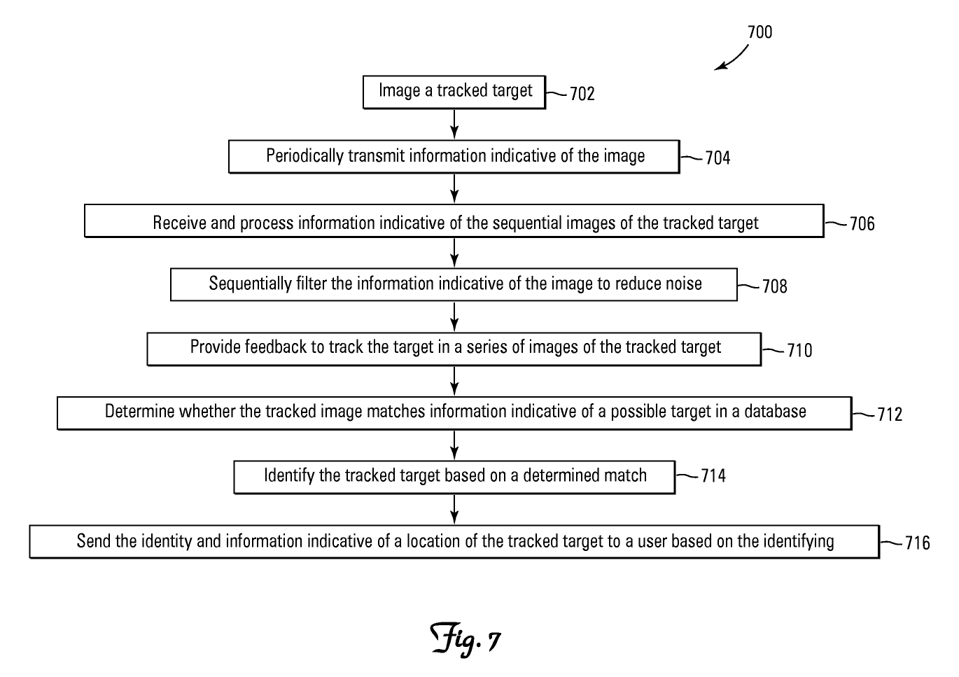

FIG. 7 is a flow diagram 700 of one embodiment of a method to identify targets in accordance with one embodiment of the present invention.

At block 702, a relatively stable image of a target 30 is generated through exponentially stabilizing control laws as the tracked target 30 moves with respect to the imaging device 50. In one implementation of this embodiment, the camera 29 is rotated to by the motors 95 to track the target 30 so the target 30 is stably imaged by the lens system 59 as the target image 130 (FIG. 4A) at the imaging plane 105 of the imaging device 50.

At block 704, information indicative of the image is periodically transmitted. In one implementation of this embodiment, camera module 28 periodically transmits information indicative of the target image 130 (FIG. 4A) to the programmable processor 80 as the camera 29 is rotated to by the motors 95 to track the target 30. The target image 130 is maintained in one position on the image plane 105 and the size of the target image 130 is maintained by the rotation of the camera 29 and the refocusing of the lens system 56 while the information indicative of the image is periodically transmitted.

At block 706, information indicative of the sequential images of the tracked target is received and the information indicative of at least two sequential images of the tracked target is processed. In one implementation of this embodiment, the programmable processor 80 receives information indicative of the sequential images of the tracked target 30 and processes the information indicative of at least two sequential images of the tracked target 30 to generate data indicative of a stable image. The data indicative of the stable image is consistent from the first sequential image to the second sequential image and the processor creates data indicative of the stable image that includes details of the target 30 that is moving with respect to the camera 29.

In one implementation of this embodiment, the information indicative of the sequential images is processed as an average of at least two images. In one implementation of this embodiment, the information indicative of the sequential images is processed as a rolling average of at least two images. In yet another implementation of this embodiment, processors in a super computer receive the information indicative of the sequential images from a plurality of cameras and/or a plurality of camera modules and processes the information indicative of sequential images to generate an image of the target. In yet another implementation of this embodiment, the geometric relationship of the system carrier with respect to the target is known and used to create a three-dimensional representation of the object, as is known in the art.

Block 708 is optional. At block 708, the information indicative of the image is sequentially filtered to reduce noise. The programmable processor 80 executes instructions to filter noise from the generated data indicative of a stable image. In one implementation of this embodiment, the filtering to reduce noise is implemented during block 706. In this latter implementation, programmable processor 80 executes instructions to filter noise from the raw data received from the camera module 28 prior to generating the stable image of the target 30. In yet another implementation of this embodiment, the filtering is executed on averaged data.

At block 710, feedback is provided to track the target in a series of images of the tracked target. In one implementation of this embodiment, the programmable processor 80 provides feedback to the motors 95 so the target is tracked in a series of images taken by the camera 29. The programmable processor 80 receives sensor data from the sensors 60, and executes instructions, including the exponentially stabilizing control laws, to generate motor instructions for the motors 95 to move the camera 29 so that a consistent image of the target 30 is imaged on the image plane 105. The motors receive the motor instructions from the programmable processor 80. In response to the motor instructions, the motors 95 rotate the optical axis 52 of the imaging device 50 so that the optical axis 52 points at the target 30 and to adjust the lens system 56 to maintain the image size of the target 30 as it is focused on the imaging plane 105. The target 30 is tracked in a series of images, such as a series of images 130 on the image plane 105 that are stable over time.

At block 712, it is determined whether the tracked image matches information indicative of a possible target in a database. In one implementation of this embodiment, while the stable image of the target 30 is maintained on the image plane 105, the programmable processor 80 determines whether the tracked image matches information indicative of a possible target in a database of the memory 82. The programmable processor 80 executes a pattern matching instructions in the instruction module 85 located in the storage medium 90 to determine if there is a match. Since the target image 130 is stable there is sufficient data available in the information indicative of the target for the programmable processor 80 to compare with the possible targets stored in the memory 82 for a robust target identification. If the target image 130 was not stabilized, the data available for comparison with the possible targets would be insufficient to make a positive match when the target 30 moved with respect to the camera 29. In another implementation of this embodiment, the stable image is a three-dimensional image. In this case, the database in the memory 82 includes three-dimensional images of the target from various viewing angles. In yet another implementation of this latter embodiment, the programmable processor 80 determines a viewing angle of the target 30. In yet another implementation of this embodiment, the programmable processor 80 executes a rotation algorithm to rotate the target image 130 that is on the imaging plane 105 prior to making the determination of a match.

At block 714, the tracked target is identified based on a determined match. In one implementation of this embodiment, the programmable processor 80 identifies the tracked target 30 based on a determined match with at least one of the possible target image stored in database of the memory 82. The match is determined in real time, while the image is being held in a stable position on the imaging plane 105 of the imaging device 50 even if the target 30 is moving with respect to the system carrier 200.

At block 716, the identity of the tracked target is sent to a user based on the identifying and the information indicative of the location of the tracked target is sent to the user of the system 190. In one implementation of this embodiment, the programmable processor 80 sends the identity of the tracked target 30 to a user of the system 190 once the target 30 is identified. The programmable processor 80 uses data from the sensors 60 (such as location sensors in a GPS system and directional sensors for the optical axis 52 of the camera 29) to determine the location of the target 30. In one implementation of this embodiment, the carrier system is an aircraft and the user is the pilot of the aircraft.

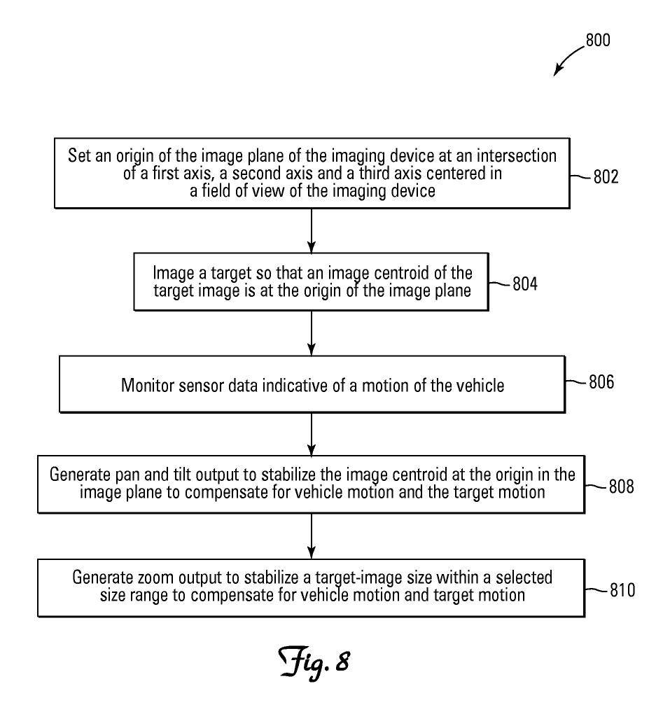

FIG. 8 is a flow diagram of one embodiment of a method 800 to dynamically stabilize a target image formed on an image plane of an imaging device located in a moving system carrier. Method 800 describes a method to compensate for system carrier motion while tracking a moving target with an imaging device located in a moving system carrier. The terms “motion of the vehicle” and “vehicle motion” are used interchangeably herein. Method 800 is outlined for an exemplary implementation of system 190 with reference to FIGS. 2 and 3.

At block 802, the origin is set in the image plane of the imaging device at the intersection of a first axis, a second axis and a third axis. The origin is set at about a center of a field of view of the imaging device. In one implementation of block 802, the origin 51 is set in the image plane 105 of the imaging device 50 at the intersection of the first axis Xᵢ, the second axis Yᵢ and the third axis Zᵢ as shown in FIG. 2. The origin 51 is set at about a center of a field of view of the imaging device 50. In another implementation of this embodiment, the imaging device 50 is positioned at a center of gravity of the vehicle 201 (FIGS. 2 and 3). In yet another implementation of this embodiment, the imaging device 50 is offset from the center of gravity of the vehicle 201. In this case, additional translation and rotation algorithms are implemented during method 800 to adjust for the offset from the center of gravity. Such translation and rotation algorithms are known in the art.

At block 804, a target is imaged so that an image centroid of the target image is at the origin of the image plane as described above with reference to FIGS. 4A-4B. In one implementation of block 804, the target 30 is imaged so that an image centroid 53 of the target image is at the origin 51 of the image plane 105. In another implementation of this embodiment, the target 30 is imaged so that an image centroid 53 of the target image 130 is near the origin 51 of the image plane 105. As defined here, the image centroid of the target image is near the origin 51 (FIGS. 2 and 3) of the image plane 105 when the image centroid within a selected distance from the origin 51. In an exemplary case, the image centroid 53 is defined as being near the origin 51 to within the selected distance if the separation between them is less than 2% of the diagonal dimension of the imaging elements within the field of view 110.

At block 806, a programmable processor monitors sensor data indicative of a motion of the vehicle. The motion of the vehicle comprises a translation and a rotation. The sensors sense the translation and the rotation of the vehicle about the inertial coordinate system and input sensor data to the programmable processor. The programmable processor receives the sensor data from the sensors and determines if there has been a translation and/or rotation of the vehicle. In one implementation of block 806, the programmable processor 80 of system 190 monitors the sensor data indicative of a motion of the vehicle 201. The programmable processor 80 is communicatively coupled to the sensors 60 via a communication link that comprises one or more of a wireless communication link (for example, a radio-frequency (RF) communication link) and/or a wired communication link (for example, an optical fiber or copper wire communication link).

At block 808, pan and tilt output are generated to stabilize the image centroid at the origin in the image plane to compensate for the vehicle motion and the target motion. The pan and tilt output are generated by implementing exponentially stabilizing control laws. The exponentially stabilizing control laws are implemented, at least in part, on the sensor data. In one implementation of block 808, the programmable processor 80 executes software that includes the exponentially stabilizing control laws in order to generate the pan and tilt output.

The moving vehicle 201 of FIGS. 2 and 3 experiences a general translation and rotation between inertial coordinates Xₒ, Yₒ and Zₒ of the vehicle 201 to imaging device coordinates Xᵢ, Yᵢ and Zᵢ as described in the Ser. No. 11/470,048 application.

The angles used in the control laws must account for vehicle motion in addition to imaging device motion from the previous control input. This is required because the movement of the imaging device 50 is based on the motors 95 which have a latency. The latency is known for a given amount of rotation. A forward integration of inertial measurements and control inputs provides the required latency offset. The zoom control law of Equation (3) automatically takes into account the translation of the moving vehicle 201.

The programmable processor 80 generates rotation output to stabilize the image centroid 53 within a selected distance from the origin 51. The rotation output is based on the output from equations (1), (2), and (3).

The system 190 maintains the image centroid within the selected distance from the origin as the vehicle moves with respect to the target as described above with reference to FIGS. 4A and 4B. The system 190 maintains the image centroid within the selected distance from the origin based on the implementation of the exponentially stabilizing control laws (equations ((1), (2), and (3) which are executed by the programmable processor to output rotation output. The programmable processor generates instructions based on the rotation output that cause at least one motor to rotate the imaging device to pan and tilt. In the exemplary embodiment shown in FIGS. 2 and 3, the programmable processor 80 generates instructions that cause at least one motor 95 to rotate the imaging device 50 about at least one of the first axis Xᵢ and the second axis Yᵢ so that the optical axis 52 of the imaging device 50 is along a line of sight to the target 30.

At block 810, the programmable processor generates zoom output to stabilize the target-image size within a selected size range to compensate for vehicle motion and target motion. The zoom output is based on the output from equations (1), (2), and (3). The selected size range is between a minimum size for the target image and a maximum size for the target image.

In one implementation of this embodiment, the maximum size is a maximum selected radius from the origin and the target image fits within the circle of the maximum selected radius centered at the origin. In this same implementation, the minimum size is a minimum selected radius from the origin and the edges of the target image extend beyond the circle of the minimum selected radius centered at the origin. In one implementation of this embodiment, the minimum size is about equal to the maximum size in order to hold the image stable. In another implementation of this embodiment, the minimum size is between 95% and 99.9% of the maximum size in order to hold the image in an approximately stable position. In yet another implementation of this embodiment, the maximum selected radius is a selected maximum percentage of the shortest dimension in the field of view of the imaging device as described above with reference to FIGS. 4A-4B.

The system 190 maintains the target-image size within the selected size range based on the implementation of the exponentially stabilizing control laws which are executed by the programmable processor 80 to generate zoom output.

The control design consists of two parts: the first is the tracking of the target image 130 on the image plane 105 (FIG. 4A) based on rotation outputs from the programmable processor 80, and the second is the regulation of target-image size on the image plane 105 by control of focal length (zoom control) based on zoom outputs from the programmable processor 80.

The zoom control ensures this over most of the field of view 110 (FIGS. 4A-4B) of the imaging device 50 (FIGS. 2 and 3). However, this control naturally degrades when the tracked target 20 is very far from the imaging device 50 or very close to the imaging device 50, and the zoom limits are reached. The zoom control degradation is ameliorated in the following ways: when the vehicle 201 is closer to the target 30, the imaging device 50 focuses on a smaller portion of the target 30, and when the target 30 is far away, the imaging device 50 focuses on a larger portion of the target 30 and the pattern matching is done on a portions of the possible target images stored in the memory 82. Moreover, for the near field problem, where the vehicle 201 approaches the target 30, the prediction time is increased and the vehicle 201 moves into position to view the target 30 once it is sufficiently far away. The rotation outputs and the zoom outputs are computed for a future time taking into account the actuator latencies.

The objective of the control laws is to maintain the center of the target image at the center of the image plane. The image center can be measured by a particle filter algorithm, as is known in the art. The pan and tilt rates control the center point (or any other reference point) of the image plane.

All the latencies, such as the latency of the actuators and the latencies of the motors, are compensated for by using the forward prediction of the tracked object's motion. The forward prediction can be performed, using a kinematic or dynamic model of the target as it relates to the \dot{x}₀, \dot{y}₀, ż₀ with xₒ, yₒ, and zₒ as described in the equations above. For example, the dynamics of a targeted tank or targeted airplane may be known and in stored in a data base in the memory. When a model of the target is not known, a double integrator point mass model of the target can be used.

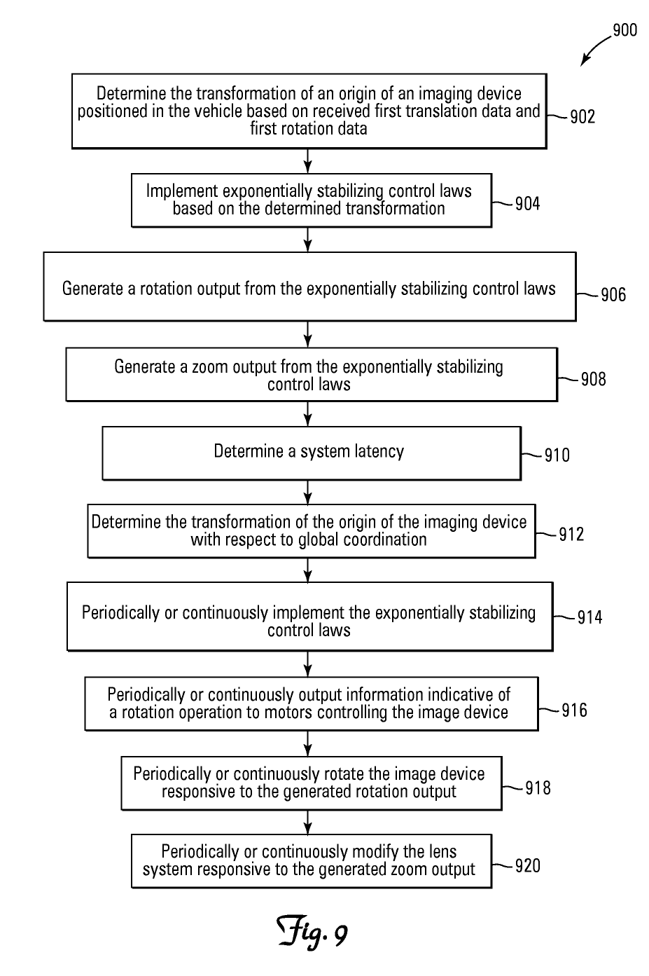

FIG. 9 is a flow diagram of one embodiment of a method 900 to dynamically stabilize a target image formed on an image plane of an imaging device located in a moving vehicle. The method 900 describes the process of tracking a target through sequential implementations of the exponentially stabilizing control laws.

At block 902, the programmable processor determines the transformation of an origin of an imaging device positioned in the vehicle based on received first translation data and first rotation data. The first translation data and first rotation data can be the first sensor data received from the sensors after the initiation of a target tracking. In one implementation of this embodiment, the programmable processor 80 determines the transformation of an origin 51 of an imaging device 50 positioned in the vehicle 201 based on first translation data and first rotation data received from the sensors 60.

At block 904, the programmable processor implements exponentially stabilizing control laws based on the determined transformation. In one implementation of this embodiment, the programmable processor 80 implements exponentially stabilizing control laws based on the transformation of the origin 51 determined at block 902.

At block 906, the programmable processor generates a rotation output from the exponentially stabilizing control laws. The rotation output is used to redirect an optical axis of the imaging device to maintain an image centroid within a selected distance from the origin of the imaging device. In one implementation of this embodiment, the programmable processor 80 generates a rotation output from the exponentially stabilizing control laws and outputs instructions to motors 95 to redirect the optical axis 52 of the imaging device 50 to maintain the image centroid 53 near the origin 51 of the imaging device 50.

At block 908, the programmable processor generates a zoom output from the exponentially stabilizing control laws to modify a lens system of the imaging device. The apparent distance between an imaged target and the imaging device is maintained since the target-image size is maintained as the moving vehicle moves towards and away from the target as described above with reference to FIGS. 4A-4B. In one implementation of this embodiment, the programmable processor 80 generates a zoom output from the exponentially stabilizing control laws and then the lens system 56 of the imaging device 50 is adjusted so the edges of the target image 130 always fits within the selected size range between circle 135 and circle 138 (FIG. 4A). By making the difference between the radius R of circle 135 and radius r of circle 138 small, the apparent distance between an imaged target 30 and the imaging device 50 in the vehicle 201 is maintained since the target-image size is maintained as the moving vehicle 201 moves towards and away from the target 30. In another implementation of this case, the complete target is always imaged within the radius R of circle 135.

At block 910, the programmable processor determines a system latency in redirecting the optical axis and modifying the lens system along the optical axis. As described above with reference to FIG. 8, the latencies of the actuators, the latency of image processing, the latency of the network, and the latency in the implementation of the control law are included in the determinations. In one implementation of this embodiment, the programmable processor 80 determines a system latency for system 190 in the redirecting the optical axis 52 and modifying the lens system 56 along the optical axis 52. In another implementation of this embodiment, the latencies of the actuators are about 100 ms, the latency of image processing is 200 ms, the latency of the network is 100 ms, and the latency in the implementation of the control law is in the range from about 50 ms to about 100 ms.

At block 912, the programmable processor determines the transformation of the origin of the imaging device with respect to global coordinates, such as the coordinates of the target. Specifically, the transformation of the body axes of the airplane with respect to an inertial reference frame fixed to the ground is determined. The second determination of block 912 follows the determination that was made during block 902. The second determination is based on second translation data and second rotation data that was monitored during at least one of the pitch, the yaw, and the roll of the vehicle that occurred during the implementation of blocks 904-908. The second determination is also based on the redirecting of the optical axis, the modifying of the lens system, and the system latency. Based on the second determination, the image centroid of the target image continues to be maintained within a selected distance from the origin of the imaging device and the apparent distance between the imaged target and the imaging device continues to be maintained. In one implementation of this embodiment, the programmable processor 80 determines the transformation of the origin 51 of the imaging device 50 with respect to global coordinates X″, Y″, and Z″ (FIGS. 2 and 3).

The programmable processor continues to determine the transformation of the origin of the imaging device with respect to global coordinates as the vehicle moves. In one implementation of this embodiment, the determinations are made periodically. In such an implementation, an exemplary period is 1 μs. In another such implementation, the exemplary period is 10 ms. In another implementation of this embodiment, the determinations are made continuously on data that is streaming into the programmable processor from the sensors 60. Blocks 914-920 are implemented based on the periodically or continuously determined transformations.

At block 914, the programmable processor periodically or continuously implements the exponentially stabilizing control laws based on the determined transformations to generate rotation output and zoom output. In one implementation of this embodiment, the programmable processor 80 periodically or continuously implements the exponentially stabilizing control laws. At block 916, the programmable processor continuously or periodically outputs information indicative of a rotation operation to the motors controlling the imaging device. In one implementation of this embodiment, the programmable processor 80 continuously or periodically outputs information indicative of a rotation operation to the motors 95 that control the rotation of the imaging device 50. In another implementation of this embodiment, the programmable processor 80 continuously or periodically outputs information indicative of a zoom operation to the motors 95 that control the lens system 56 of the imaging device 50 in order to offset for a translation and/or roll of the vehicle 201.

At block 918, the programmable processor periodically or continuously rotates the imaging device responsive to the generated rotation output to continuously maintain the image centroid to within the selected distance from the origin of the imaging device.

At block 920, the motors periodically or continuously modify of the lens system responsive to the generated zoom output so that the apparent distance between the imaged target and the imaging device is continuously maintained by compensating for the vehicle motion.

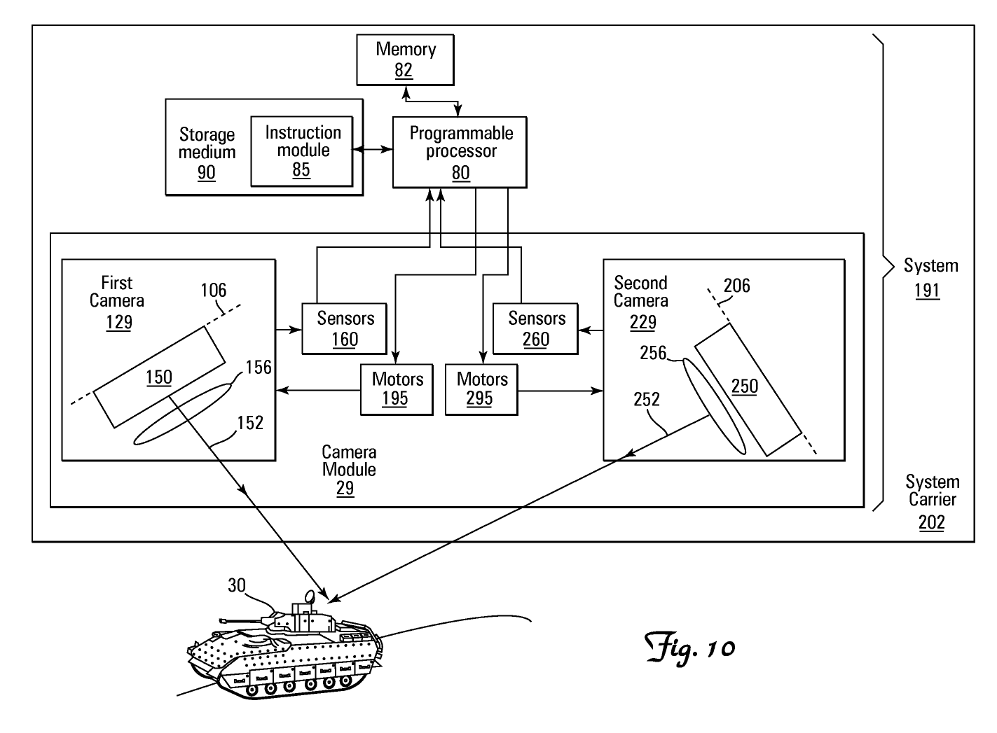

FIG. 10 is a block diagram of one embodiment of a system 191 to identify targets 30 in accordance with one embodiment of the present invention. As shown in FIG. 10, the system 191 includes a camera module 29 having a first camera 129 and a second camera 229 to provide information indicative of a depth of the tracked target 30. In one implementation of this embodiment, the first camera 129 and the second camera 229 have pan, tilt and zoom capability. The camera module 29 generates a stable stereoscopic image a moving target while the camera module 29 is moving with respect to the target 30.

During operation of the camera module 29, the optical axis 152 of the first camera 129 points toward the target 30 and the optical axis 252 of the second camera 229, which is offset from the first camera 129, points towards the target 30. In one implementation of this embodiment, the sensors 160 provide input to the programmable processor 80 about the movement of the first camera 129 and the sensors 260 provide input to the programmable processor 80 about the movement of the second camera 229. The programmable processor 80 generates motor instructions for the motors 195 based on the sensor data received from the sensors 160. The motors 195 then position the first camera 129 to focus an image of the target 30 on the image plane 106 of the first camera 129. Likewise, programmable processor 80 generates motor instructions for the motors 295 based on the sensor data received from the sensors 260. The motors 295 then position the second camera 229 to focus an image of the target 30 on the image plane 206 of the second camera 229. In this manner a stereoscopic image of the target 30 is generated.

In one implementation of this embodiment, the sensors 160 provide input to the programmable processor 80 about the movement of the first camera 129 and the second camera 229. The programmable processor 80 generates motor instructions for the motors 195 and the motors 295 based on the sensor data received from the sensors 160. The motors then position the cameras to focus an image of the target 30 to generate a stereoscopic view of the target 30.

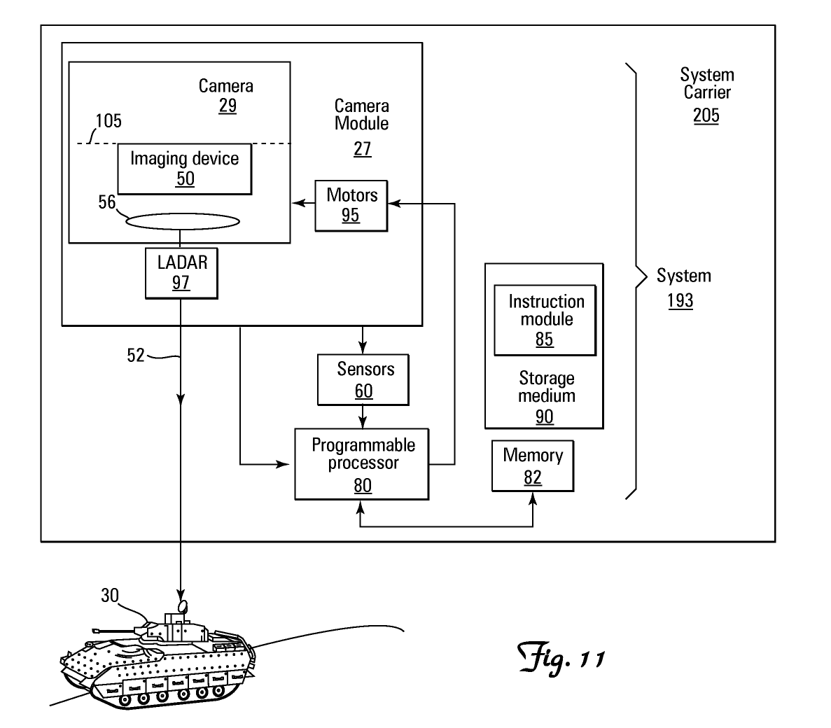

FIG. 11 is a block diagram of one embodiment of a system 193 to identify targets 30 in accordance with one embodiment of the present invention. As shown in FIG. 11, the camera module 27 comprises a scanning laser radar (LADAR) 97 as described in the H0012162-5607 Application. The laser radar 97 provides depth and displacement information of the target 30 and the database of possible targets includes information indicative of three-dimensional images of possible targets. In this implementation, the programmable processor can output information about the viewing angle of the target that is imaged on the imaging device 50. In one implementation of this embodiment, the camera and the LADAR 97 are a single unit.

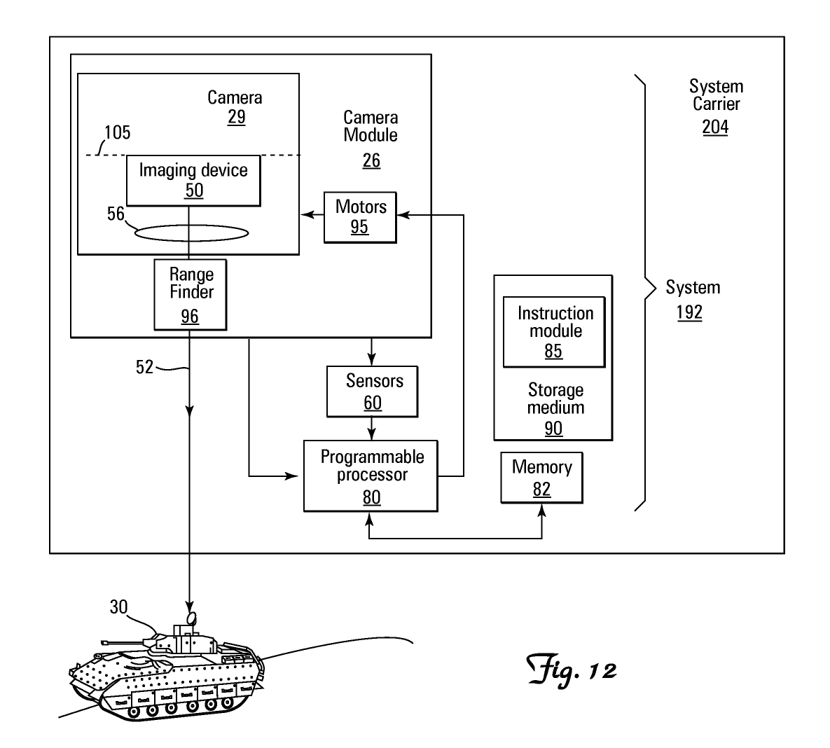

FIG. 12 is a block diagram of one embodiment of a system 193 to identify targets 30 in accordance with one embodiment of the present invention. As shown in FIG. 12, the camera module 26 comprises a camera 29 and a range finder 96 fused as one device. The range finder determines the distance to the target 30, while a stable image of the target 30 is imaged on the image plane 105 of the imaging device 50. Range finders are known in the art.

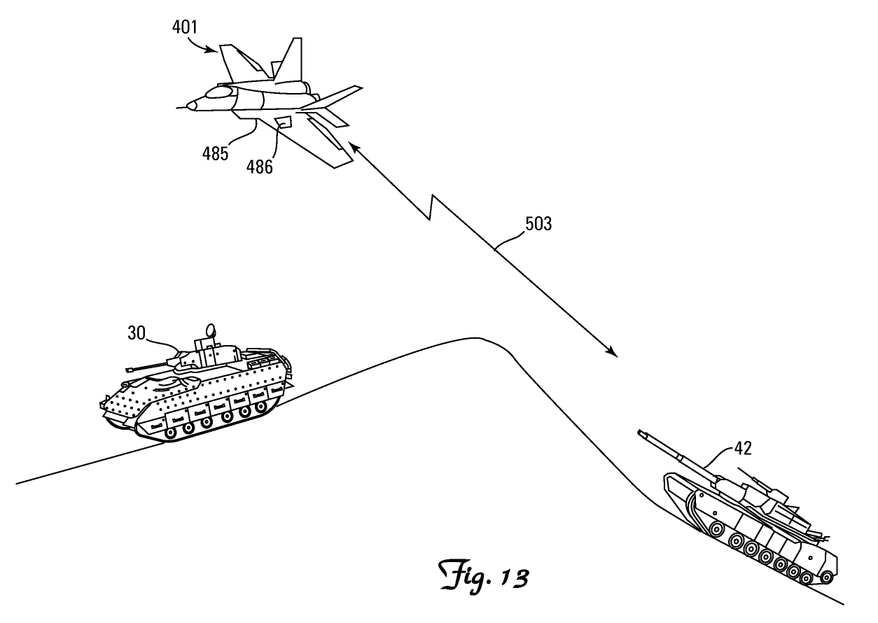

FIG. 13 is a block diagram of one embodiment of a system 485 to identify targets 30 in accordance with one embodiment of the present invention. System 485 is similar in structure and function to one of system 190, 191, 192, or 193 and includes a wireless transceiver 486 which is shown external to system 485. As shown in FIG. 13, the programmable processor 80 in system carrier 401 sends the identity and location of the tracked target 30 to a user positioned in another vehicle 42. In the illustrated embodiment, the system carrier 401 is an airborne vehicle 401. The airborne vehicle 401 views the target 30 and sends the identity and location of the tracked target 30 via the wireless communication link 503 to personnel in a tank 42 that does not yet have the target 30 in view. The tank 42 can then move into a position to bomb the target 30. In some cases the tank 42 can bomb the target without ever coming into view of the target 30, since the location of the target 30 is known.

In another implementation of this embodiment, the tank 42 includes the system 485, views the target 30 and sends the identity and location of the target 30 to the airborne vehicle 401. In this case, the airborne vehicle 401 moves into position to bomb the target 40 from the air.

In one implementation of the illustrated embodiments of FIGS. 1-13, the database of possible targets includes databases in more than one remotely located database. For example, in implementation of FIG. 6, the system carrier 202 and system carrier 400 are representative of a plurality of camera systems on utility poles in a city and the targets include people walking the streets of the city. In this case, the plurality of system carriers communicate with a central programmable processor that is communicatively coupled to a central database that includes images of terrorists as the possible targets. In one implementation of this case, a central programmable processor determines a match between the images sent from the plurality of camera systems and a central database. In another implementation of this case, the programmable processor at each system in the plurality of camera systems determines a match between the images and if a match to a possible terrorist is determined, the system sends the identity and location of the target via a transceiver, such as transceiver 391, to a user of the central programmable processor.

In one implementation of embodiments described herein, the possible targets include a cluster of images at various angles in two dimensions. In this case, the programmable processor in the system executes a convergence algorithm to guess the viewing angle of the target.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory.

Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A system to identify targets comprising:
a camera module to track a target and to generate a relatively stable image of the target while the target moves with respect to the camera module;
sensors to sense a movement of the camera module and to generate sensor data;
a memory storing a database of possible targets; and
a programmable processor communicatively coupled to each of the memory, the camera module and the sensors, wherein the programmable processor receives signals comprising information indicative of the image from the camera module and executes instructions in an instruction module, the instructions comprising exponentially stabilizing control laws based at least in part on the sensor data, and wherein the programmable processor executes instructions in the instruction module to determine a pattern match between the stable image of the target and one of the possible targets in the database.

2. The system of claim 1, the system further comprising:
a system carrier in which the camera module is located, wherein the camera module comprises:
an imaging device having an image plane including an origin at an intersection of a first axis, a second axis and a third axis, and wherein the sensors sense translation and rotations of the system carrier about a fourth axis, a fifth axis and a sixth axis, wherein the programmable processor executes instructions in an instruction module to implement the exponentially stabilizing control laws to maintain an image centroid of a target image at the origin of the image plane, the programmable processor communicatively coupled to receive sensor data from the sensors and to generate rotation output to stabilize the target image formed on the image plane of the imaging device when the system carrier moves with respect to a target and wherein the programmable processor implements the exponentially stabilizing control laws to maintain a target-image size within a selected size range as the system carrier moves with respect to the target, wherein the programmable processor generates zoom output to stabilize the target-image size within the selected size range when the system carrier moves with respect to the target.

3. The system of claim 2, wherein system carrier is a moving vehicle.

4. The system of claim 1, wherein the camera module comprises:
two cameras having pan, tilt and zoom capability to provide information indicative of a depth of the tracked target.

5. The system of claim 1, wherein the camera module comprises a scanning laser radar, the laser radar providing depth and displacement information of the target and wherein the database of possible targets includes information indicative of three-dimensional images of possible targets.

6. The system of claim 1, further comprising a network of camera modules each camera module communicatively coupled to the programmable processor, wherein the programmable processor receives signals comprising information indicative of the images from the camera modules.

7. The system of claim 6, wherein the programmable processor is a first programmable processor and the camera module is a first camera module, the system further comprising:
a second programmable processor located at a distance from the first programmable processor, wherein the second programmable processor receives instructions to track the target from the first programmable processor; and
a second camera module to track the target and to generate a stable image of the target while the target moves with respect to the second camera in response to receiving the instructions to track the target, wherein the second programmable processor executes instructions in the instruction module, the instructions comprising exponentially stabilizing control laws based at least in part on the sensor data responsive to receiving the instructions to track the target.

8. The system of claim 1, wherein the camera module comprises:
a camera and a range finder fused as one device.

9. A method to identify and locate targets that move with respect to an imaging device, the method comprising:
generating a relatively stable image of a target through exponentially stabilizing control laws;
periodically transmitting information indicative of the image;
processing the information indicative of the image;
providing feedback to track and locate the target in a series of images of the tracked target; and
determining whether the tracked image matches information indicative of a possible target in a database.

10. The method of claim 9, the method further comprising:
sequentially filtering the information indicative of the image to reduce noise.

11. The method of claim 9, the method further comprising:
receiving information indicative of the sequential images of the tracked target; and
processing the information indicative of at least two sequential images of the tracked target.

12. The method of claim 9, the method further comprising:
identifying the tracked target based on a determined match.

13. The method of claim 12, the method further comprising:
sending the identity of the tracked target to a user based on the identifying.

14. The method of claim 13, the method further comprising:
sending information indicative of a location of the tracked target to the user.

15. The method of claim 11, the method further comprising:
setting an origin in an image plane of an imaging device at an intersection of a first axis, a second axis and a third axis, wherein the third axis is an optical axis of the imaging device;
imaging a target so that an image centroid of the target image is at the origin of the image plane;
monitoring sensor data indicative of a motion of a vehicle that houses the imaging device; and
generating pan and tilt output to stabilize the image centroid at the origin in the image plane to compensate for vehicle motion and target motion, wherein the pan and tilt output are generated by implementing exponentially stabilizing control laws, wherein implementing the exponentially stabilizing control laws is based at least in part on the sensor data.

16. The method of claim 15, wherein the vehicle motion comprises a translation and a rotation, and wherein generating pan and tilt output comprises:
generating rotation output to stabilize the image centroid within a selected distance from the origin;
maintaining the image centroid within the selected distance from the origin as the vehicle moves with respect to the target based on the rotation output,
the method further comprising generating zoom output to stabilize the target-image size within a selected size range to compensate for the vehicle motion and the target motion; and
maintaining a target-image size within the selected size range as the vehicle moves with respect to the target, based on the zoom output.

17. The method of claim 9, the method further comprising:
rotating the image about the image centroid.

18. A system to identify targets comprising:
means for tracking a target that moves with respect to the tracking means;
means for exponentially stabilizing the images generated by the means for tracking; and
means, responsive to the means for exponentially stabilizing, for identifying the tracked target.

19. The system of claim 18, wherein the means for generating a stable image the tracked target comprises:
means for determining a depth of the tracked target.

20. The system of claim 18, further comprising:
means for communicating the identity of the tracked target.
